(19) United States
(12) Patent Application Publication
(10) Pub. No.: US 2020/0067245 A1
(43) Pub. Date: Feb. 27, 2020

(54) LOCKABLE POWER OUTLET CONTROL PLUG AND SYSTEM AND METHOD OF USING SAME TO CONNECT AND DISCONNECT POWER TO AN ELECTRICAL DEVICE

(71) Applicant: Matthew Stearns Maley, Manhasset, NY (US)

(72) Inventor: Matthew Stearns Maley, Manhasset, NY (US)

(21) Appl. No.: 16/545,188

(22) Filed: Aug. 20, 2019

Related U.S. Application Data
(60) Provisional application No. 62/722,455, filed on Aug. 24, 2018.

(51) Int. Cl. H01R 31/06; H01R 13/639; H01R 13/516; G08B 5/22; G06F 1/26

(52) U.S. Cl. CPC H01R 31/065; H01R 13/639; G06F 1/266; G08B 5/224; H01R 13/516

(57) ABSTRACT

A system for monitoring electrical device usage and controlling power thereto includes a plurality of power outlet control plugs and an external computing device in electrical communication therewith. Each power outlet control plug includes a smart plug in electrical communication with an electrical device. The smart plug includes electrical circuitry, power prongs that are receivable by an AC wall outlet and a power receptacle that includes slots into which the plug of the power cord of an electrical device is received. The electrical circuitry of the smart plug is selectively switchable between a first state and a second state to selectively connect and disconnect power from the AC wall outlet to the electrical device. The external computing device provides a control signal to the smart plug of one of the power outlet control plugs to selectively switch the electrical circuitry thereof between the first state and the second state.

### CROSS-REFERENCE TO RELATED APPLICATIONS

This application is related to U.S. Provisional Patent Application Ser. No. 62/722,455, filed on Aug. 24, 2018, and entitled “Lockable Power Outlet Control Plug and Method of Using Same to Connect and Disconnect Power to an Electrical Device”, the disclosure of which is hereby incorporated by reference and on which priority is hereby claimed.

### BACKGROUND OF THE INVENTION

### Field of the Invention

The present invention generally relates to the use of a “smart plug” to control power provided to an electrical device connected thereto. More particularly, the present invention relates to parental control using such a smart plug over the time and duration that a child uses a media or interactive device.

### Description of the Prior Art

The present invention gives parents a simple yet powerful tool to manage their children's screen time at home. Statistics have shown that there are approximately thirty-three million households in the United States with children under the age of eighteen. Ninety-five percent of these households have a TV in the home, and eighty-three percent have a video game console. Furthermore, seventy-one percent of U.S. households have WiFi.

Statistics have also shown that, with respect to screen media, such as televisions, daily screen time of the average teenager is six hours and forty minutes. More specifically, two hours and thirty-eight minutes is spent watching television, one hour and twenty-one minutes is spent on gaming using screen media, and one hour and eleven minutes is spent using social media. Fifty percent of teenagers spend more than four hours daily with screen media, and twenty-six percent spend more than eight hours daily with screen media.

Statistics also show that, with respect to the use of game consoles and gaming, the average gaming session of teenagers is two hours and nine minutes. Twenty-eight percent play one to two hours per session, twenty percent play two to four hours, and twelve percent play four or more hours. Accordingly, it is incumbent upon parents to control the time and duration that their children watch television or the like or play console video games, so that more time may be allocated to physical activities and exercise, homework and reading.

### OBJECTS AND SUMMARY OF THE INVENTION

It is an object of the present invention to provide a device which a parent can use to control the time and duration a child may use a television or gaming device.

It is another object of the present invention to provide a power outlet control plug which a parent may use to connect and disconnect power to an electrical device, such as a television or a gaming console, which the child is using.

It is still another object of the present invention to provide a power outlet control plug for controlling power to an electrical device, which control plug has a lockable feature which may be selectively attached and locked to the plug on a power cord of a television, gaming console or other electrical device.

It is a further object of the present invention to provide a system in which a parent has interactive control over the use by a child of an electrical device, such as a television or gaming console, even remotely from the device.

It is yet a further object of the present invention to provide a system in which a parent can monitor the use of an electrical device, such as a television or a gaming console, by a child, and control the energization and deenergization of the electrical device.

It is still another object of the present invention to provide a system for controlling the energization and deenergization of an electrical device, and which provides reports to the controller (e.g., a parent) of the system with respect to the usage of the electrical device.

In one form of the present invention, a system envisioned to be used by a parent to control the time and duration that a child uses an electrical device, such as a television or a gaming console, includes a WiFi power outlet control plug that has a lockable feature to selectively prevent the removal of a power plug of the electrical device that is plugged into the power outlet control plug. The WiFi power outlet control plug receives a digitally coded signal sent wirelessly from a router in the household where the electrical device is located. The control plug is mounted on a wall outlet, and passes power therethrough to the electrical cord of the device, such as a television or gaming console, which is connected thereto. A parent, using a smart phone or a laptop or personal computer, or other “smart” device, can remotely send a signal over the internet or cellular communication network, which signal is received by a modem in the household and transmitted to a wireless router. The wireless router sends a digitally coded signal to the lockable control plug to connect or disconnect power to the electrical device, such as a television or gaming console, connected thereto.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a diagrammatic view of a system formed in accordance with the present invention for providing parental control over a child's use of a media device, such as a television or gaming console.

FIG. 2 is a block diagram of a system formed in accordance with the present invention for providing parental control over a child's use of a media device, such as a television or gaming console.

FIG. 3 is a perspective view of one form of a WiFi power outlet control plug formed in accordance with the present invention.

FIG. 4 is a top plan view of the WiFi power outlet control plug of the present invention shown in FIG. 3.

FIG. 5 is a side elevational view of the Wifi power outlet control plug of the present invention shown in FIGS. 3 and 4.

FIG. 6 is an end view of the WiFi power outlet control plug of the present invention shown in FIGS. 3-5.

FIG. 7 is a perspective view of the WiFi power outlet control plug of the present invention shown in FIGS. 3-6, and also illustrating a lockable feature of the control plug.

FIG. 8 is a top plan view of the WiFi power outlet control plug of the present invention shown in FIG. 7.

FIG. 9 is a cross-sectional view of the WiFi power outlet control plug shown in FIGS. 7 and 8, taken along line A-A of FIG. 8.

FIG. 10 is a side elevational view of the WiFi power outlet control plug of the present invention shown in FIGS. 7-9.

FIG. 11 is an end view of the WiFi power outlet control plug of the present invention shown in FIGS. 7-10.

FIGS. 12-34 are screenshots of the display of a graphical user interface of a parent's smart phone, illustrating a method of the present invention for providing parental control over a child's use of a media device, such as a television or gaming console.

FIGS. 35 and 36 are screenshots of a display of a graphical user interface of a child's smart phone, illustrating the method of the present invention for providing parental control over a child's use of a media device, such as a television or gaming console.

FIG. 37 is a block diagram of the external computing device formed in accordance with the present invention.

### DETAILED DESCRIPTION OF THE PREFERRED EMBODIMENTS

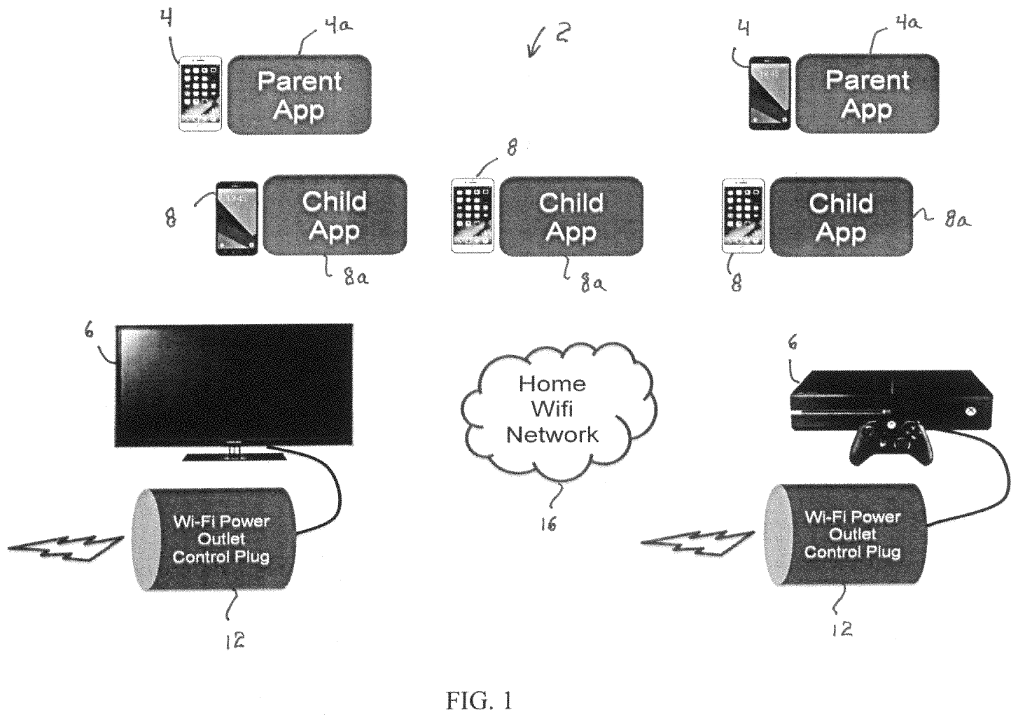

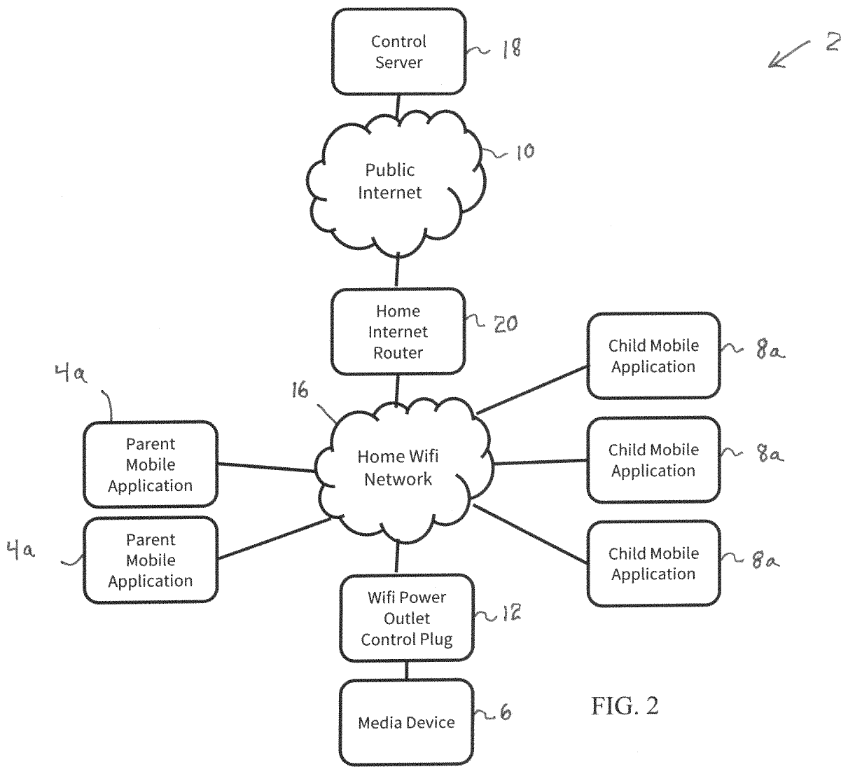

An overall generalized block diagram of the system 2 of the present invention for parental control over a child's use of a television or gaming console 6 is shown in FIGS. 1 and 2 of the drawings. As can be seen from FIGS. 1 and 2, a parent App 4a is downloaded onto one or more parents' smart phone 4. This App 4a allows the parent to communicate remotely through a cellular communication network or through the Internet 10, or directly with a WiFi power outlet control plug 12, which incorporates what is commonly referred to as a “smart” plug 14. Furthermore, the system 2 of the present invention envisions that an App 8a be downloaded onto each child's smart phone 8, this App 8a also controlling the energization and deenergization of an electrical device 6, such as a television or gaming console, each being connected to a WiFi power outlet control plug 12, under the supervision of a parent, as controlled by the parent's App 4a.

More specifically, each parent, such as a mother and father, using the App 4a downloaded on his and her cellular phone (or laptop, personal computer, handheld personal assistant device and the like) 4, can send signals to a WiFi power outlet control plug 12 to which a media device 6 is connected through a home WiFi network 16. Furthermore, each child may control the energization and deenergization of the media device 6 connected to a WiFi power outlet control plug 12 by signals sent by the child's cellular phone 8 to the home WiFi network 16, all under the parent's supervision. Informational signals, such as time and duration, and notifications, are generated by a control server 18 connected to a home internet router 20 through the internet and are provided to the parent's smart phone 4 and the child's smart phone 8, as will be explained in greater detail.

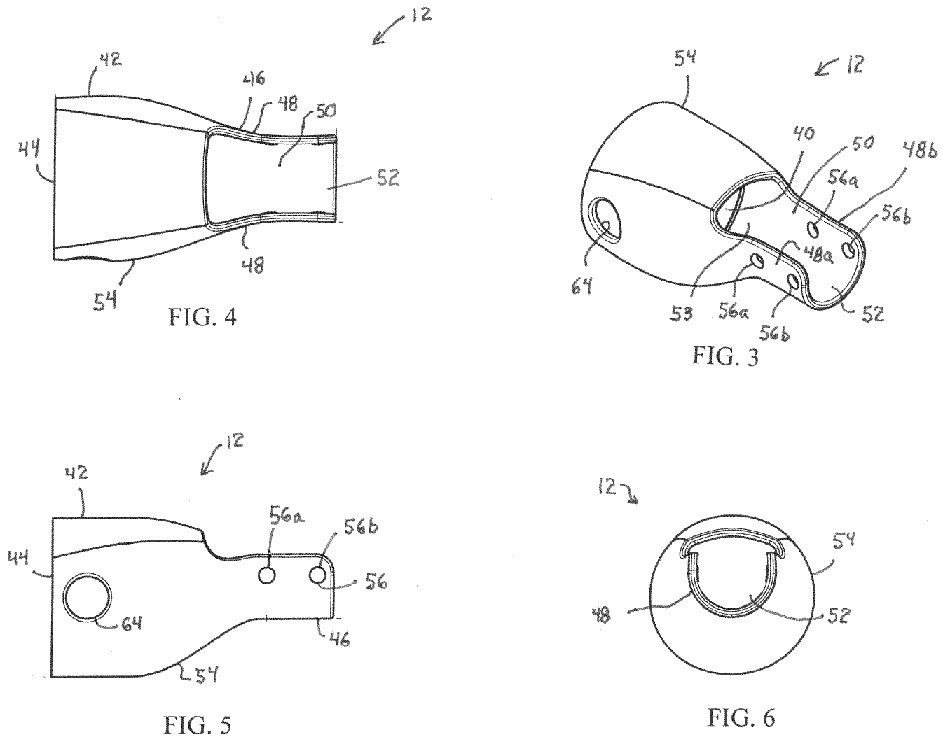

A preferred form of a WiFi power outlet control plug 12, which incorporates a conventional smart plug 14, such as Model No. AWP02L-N Mini Smart Socket manufactured by PowerBear of China, is shown in FIGS. 3-11 of the drawings. A conventional smart plug 14 has a generally cylindrical housing 22, an outer face 24 on which is mounted two power prongs 26 and a ground prong 28 and an opposite inner face 30 on which is mounted a receptacle 32 having power contacts 33 and a ground contact 34 and into which the plug 36 at the end of a power cord 38 connected to an electrical device 6, such as a television or gaming console, may be mounted. The power prongs 26 and ground prong 28 on the outer face 24 of the smart plug 14 may be plugged into a wall outlet to selectively provide power, through the smart plug 14, to the electrical device 6 which is connected thereto. The smart plug 14 includes electrical circuitry 158 situated within the housing 22 thereof that selectively electrically connects and disconnects the power prongs 26 and ground prong 28 of the smart plug 14 and the contacts of the receptacle 32 of the smart plug 14.

The WiFi power outlet control plug 12 of the present invention also includes a cowling 54 which surrounds the cylindrical housing 22 of the smart plug 14. More specifically, the cowling 54 defines an interior cylindrical bore 40 that closely receives the cylindrical housing 22 of the smart plug 14 at the forward portion 42 thereof, the power and ground prongs 26, 28 of the smart plug extending outwardly through an open front end 44 of the cowling 54. The rearward portion 46 of the cowling 54 includes a U-shaped (in transverse cross-section) sidewall 48 having an open top 50 and open axial rear end 52. The top and end openings 50, 52 formed in the rearward section 46 of the cowling 54 are provided to allow the plug 36 at the end of a power cord 38 of the electrical device 6 to be easily inserted therethrough and into the receptacle 32 of the smart plug 14 fitted in the forward section 42 of the cowling 54.

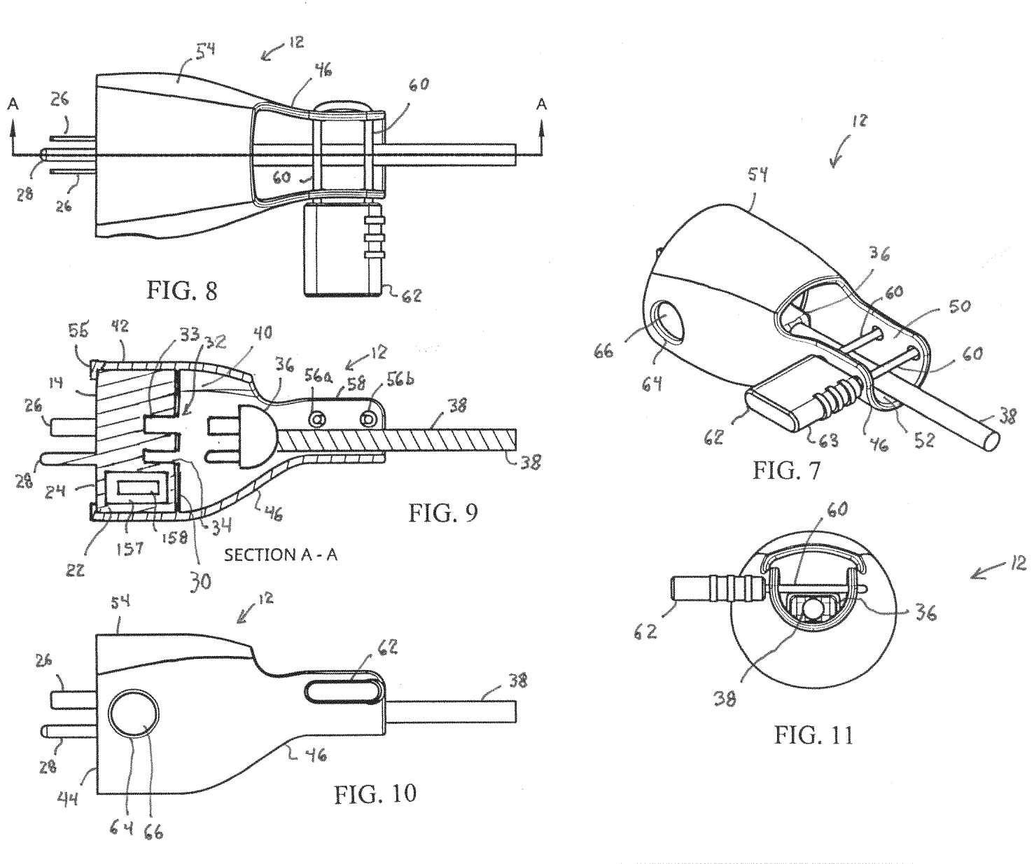

The rearward section 46 of the cowling 54 also includes structure which can selectively lock the plug 36 on the end of the power cord 38 of the electrical device 6 to the WiFi power outlet control plug 12 to prevent the removal therefrom. In one form, this locking structure includes two spaced apart holes 56 formed in opposing top end portions 58 of the U-shaped sidewall 48 of the cowling 54 that face one another across the open rear axial end 52 of the cowling 54. More specifically, a pair of holes 56 formed through the thickness of one sidewall end is situated in alignment with a pair of holes 56 formed through the thickness of the opposite sidewall end, the holes 56 being provided to allow the insertion of a flexible cable 60 that forms part of a lock 62 (see FIGS. 7-11 of the drawings). With this lock 62 in place, the cable 60 of the lock 62, passing through the sidewall holes 56, prevents the plug 36 of the power cord 38 of the electrical device 6 from being disconnected from the WiFi power outlet control plug 12 so that a child may not remove the power plug 36 from the WiFi power outlet control plug 12 to defeat the purpose of the control plug 12.

At the forward portion 42 of the cowling sidewall that surrounds the cylindrical housing 22 of the smart plug 14, there is preferably a hole 64 formed through the thickness thereof, which hole 64 is situated in alignment with an on/off power push button switch 66 mounted on the cylindrical housing 22 of the smart plug 14 so that the on/off power switch 66 on the smart plug 14 is accessible by the user of the WiFi power outlet control plug 12 through the opening 64 formed in the cowling 54.

The cowling 54 is structured so that the smart plug 14 is not removable therefrom. In one form, an adhesive may be provided between the outer wall of the cylindrical housing 22 of the smart plug 14 and the inner wall of the cowling 54 to secure the smart plug 14 to the cowling 54 and to prevent its removal therefrom. In another form, the cowling 54 and the cylindrical housing 22 of the smart plug 14 may be integrally formed together. In yet another form of the present invention, the cowling 54 may include a radially inwardly extending lip or flange 55 at the forward opening 44 thereof to which the cylindrical housing 22 of the smart plug 14 abuts against to prevent the smart plug 14 from being removed through the forward open end 44 of the cowling 54.

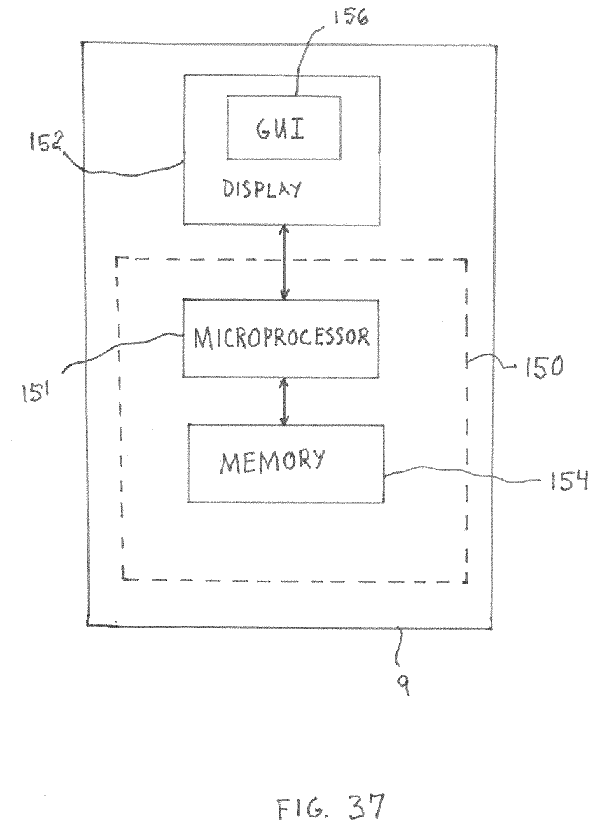

The parents' smart phone 4 and the childs' smart phone 8, which generally may be formed as any external computing device 9, such as a laptop computer, a personal computer, a cellular telephone, a handheld, portable, personal assistant device or a tablet and a remote control, includes electrical circuitry 150, including a microcontroller or microprocessor 151, a display 152, a non-transitory computer-readable storage medium 154 and, optionally, a graphical user interface (“GUI”) 156, as shown in FIG. 37 of the drawings. The non-transitory computer-readable storage medium 154 may include at least one of a random access memory (RAM), a dynamic random access memory (DRAM), a digital storage disk and a read only memory (ROM).

The electrical circuitry 150 of the external computing device 9 is in electrical communication with the power outlet control plug 12. The electrical circuitry 150 of the external computing device 9 provides at least one control signal to the electrical circuitry 158 of the smart plug 14 of the at least one power outlet control plug 12, the at least one control signal provided by the at least one external computing device 9 causing the electrical circuitry 158 of the smart plug 14 of the power outlet control plug 12 to switch between a first state in which the power prongs 26 and the contacts of the receptacle 32 are electrically connected and a second state in which the power prongs 26 and the contacts of the receptacle 32 are electrically disconnected. The display 152 of the external computing device 9 is in electrical communication with the electrical circuitry 150 of the external computing device 9. The non-transitory computer-readable storage medium 154 is situated on the external computing device 9 and is in electrical communication with the electrical circuitry 150 of the external computer device 9. The non-transitory computer-readable storage medium 154 includes instructions stored thereon that upon execution by the external computing device 9 cause the acts comprising:

receiving an instruction from a user of the system 2 directing the system 2 to either provide power from an AC wall outlet, to which the power outlet control plug 12 is connected, to the electrical device 6 (e.g., television, gaming console or the like) or not to provide power from the AC wall outlet to the electrical device 6; and

causing the at least one control signal to be generated, the electrical circuitry 158 of the at least one power outlet control plug 12, in response to the control signal, causing the electrical circuitry 158 of the smart plug 14 of at least one power outlet control plug 12 to switch to one of the first state and the second state.

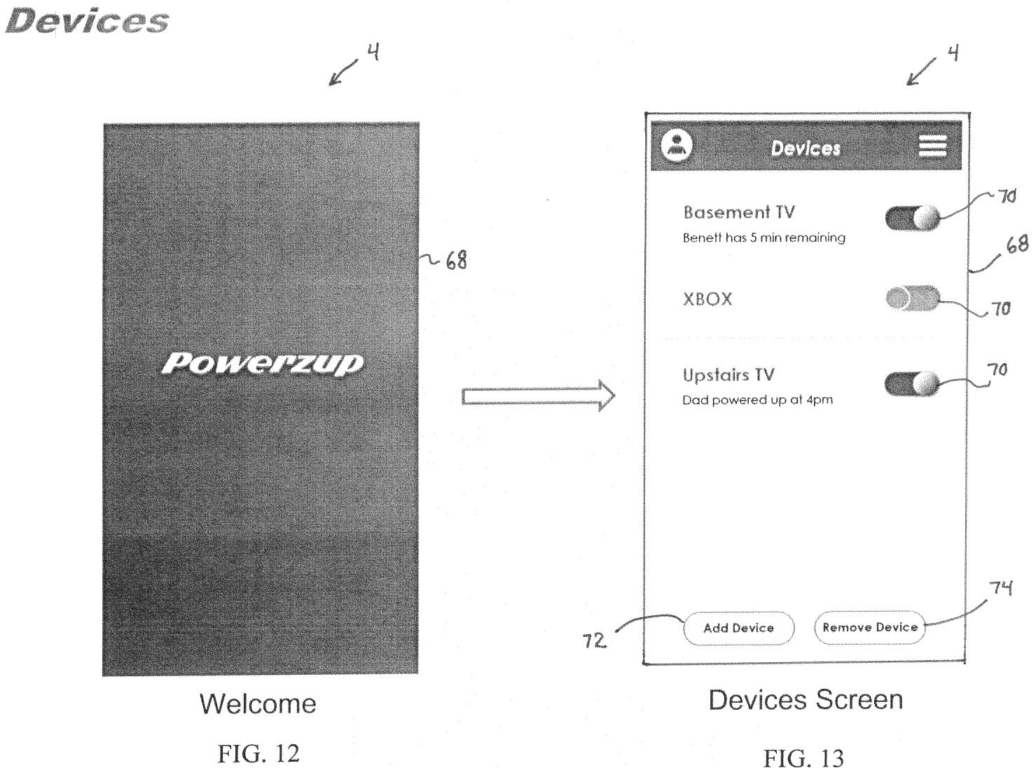

FIGS. 12-36 illustrate screenshots of the displays 68 shown on the parent's smart phone 4 and the child's smart phone 8, and such screenshots, as will now be explained, illustrate the preferred method of parental control over a child's use of a television, gaming console or other electrical device 6, using the lockable WiFi power outlet control plug 12 of the present invention.

The App 4a downloaded on the parent's smart phone 4 will now be described. As shown in FIG. 12 of the drawings, when the App 4a is opened, a “Welcome” screen is displayed on the parent's smart phone 4. Then, the App 4a progresses to display a “Devices Screen”, as shown in FIG. 13, which lists the devices 6 which are controllable by a WiFi power outlet control plug 12, and whether the control plug 12 is activated or deactivated for a particular listed device 6. For example, and as shown in FIG. 13, the Devices Screen on the parent's smart phone display 68 indicates that the television in the basement of the household (“Basement TV”) is connected to a WiFi power outlet control plug 12 that is activated, shown by the slide switch 70 displayed adjacent to the device name in a position to the right. Also, information is provided to the parent on the Devices Screen display 68 relating to that particular device 6, for example, the time remaining for a child watching the device (“Benett has 5 min remaining”), or some other message, information or notification to the parent.

When the slide switch 70 adjacent to the listed device 6 is positioned to the left, this indicates that the control plug 12 to which the device 6 is connected is deactivated (see the slide switch associated with the “XBOX” listed device).

At the bottom of the Devices Screen there is the depiction of two push button switches 72, 74, which are labeled “Add Device” and “Remove Device”. By moving a cursor shown in the form of a hand over one of these icons (if the parent is using a device with a non-touch screen), or if the parent touches one of these button icons 72, 74 on a touch screen display of his smart phone 4 with his finger, the parent can program the App 4a to add an electrical device 6 or remove an electrical device 6 from the list of devices which are controlled by the App 4a.

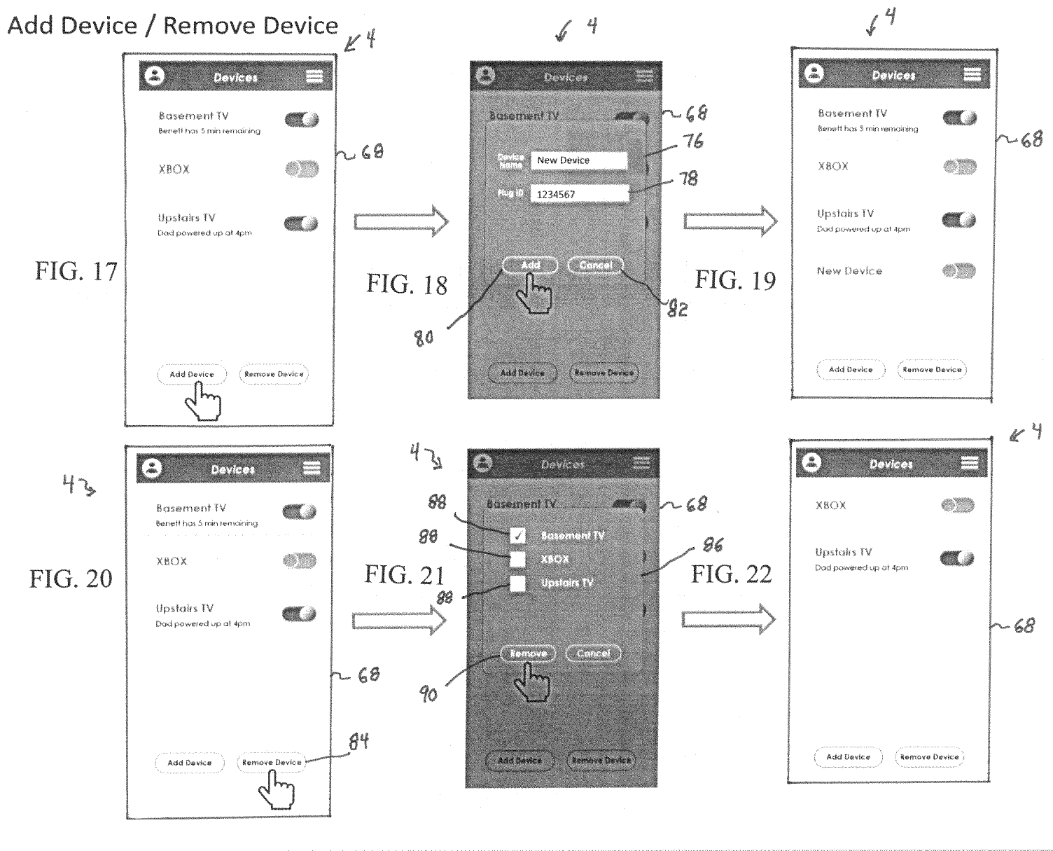

For example, and as shown in FIGS. 17-19, which are screenshots of the parent's display 68 on his or her smart phone 4, when the “Add Device” button icon 72 is pressed, as shown in FIG. 17, the display screen shown in FIG. 18 will now appear on the parent's smart phone 4. More specifically, a first field 76 will be displayed in which the parent may enter a reference name for a new electrical device 6 that is added (shown in the “Device Name” field as “New Device”). Also, there is an identification number associated with the smart plug 14 of the WiFi power outlet control plug 12, and this identification number is entered in the “Plug ID” field 78. Pressing a displayed “Add” button icon 80 will add this information to the App 4a so that the new device 6 may be controlled by the parent. There is also a “Cancel” button icon 82 that is displayed, in the event that the parent wishes to cancel entry of the device name or Plug ID. The display on the parent's smart phone 4 will then show the screenshot illustrated by FIG. 19 of the drawings, which indicates that the “New Device” (whatever the reference name of the device is entered as) will be listed on the display 68 as one of the devices 6 controlled by the parent's App 4a.

The steps and the screenshots associated with removing a device 6 from the system 2 of the present invention is shown in FIGS. 20-22 of the drawings. More specifically, and as shown in FIG. 20, when the “Remove Device” button icon 84 is pressed, the display 68 on the parent's smart phone 4 will show a field 86 with the listed electrical devices 6 controlled by the system 2 of the present invention (for example, “Basement TV”, “XBOX” and “Upstairs TV”), as shown in FIG. 21 of the drawings. A box 88 next to each listed device name may be checked to remove that device 6 from being controlled by the App 4a and system 2 of the present invention. For example, and as shown in FIG. 21 of the drawings, by the parent adding a check mark to the box next to the name “Basement TV”, and then clicking on the “Remove” button icon 90, this will cause the Basement TV to be removed from the control of the parent App 4a and the system 2. When this occurs, the parent's smart phone 4 will display the screenshot shown in FIG. 22. Note that the “Basement TV” device 6 is no longer listed as one of the devices controlled by the App 4a and system 2 of the present invention.

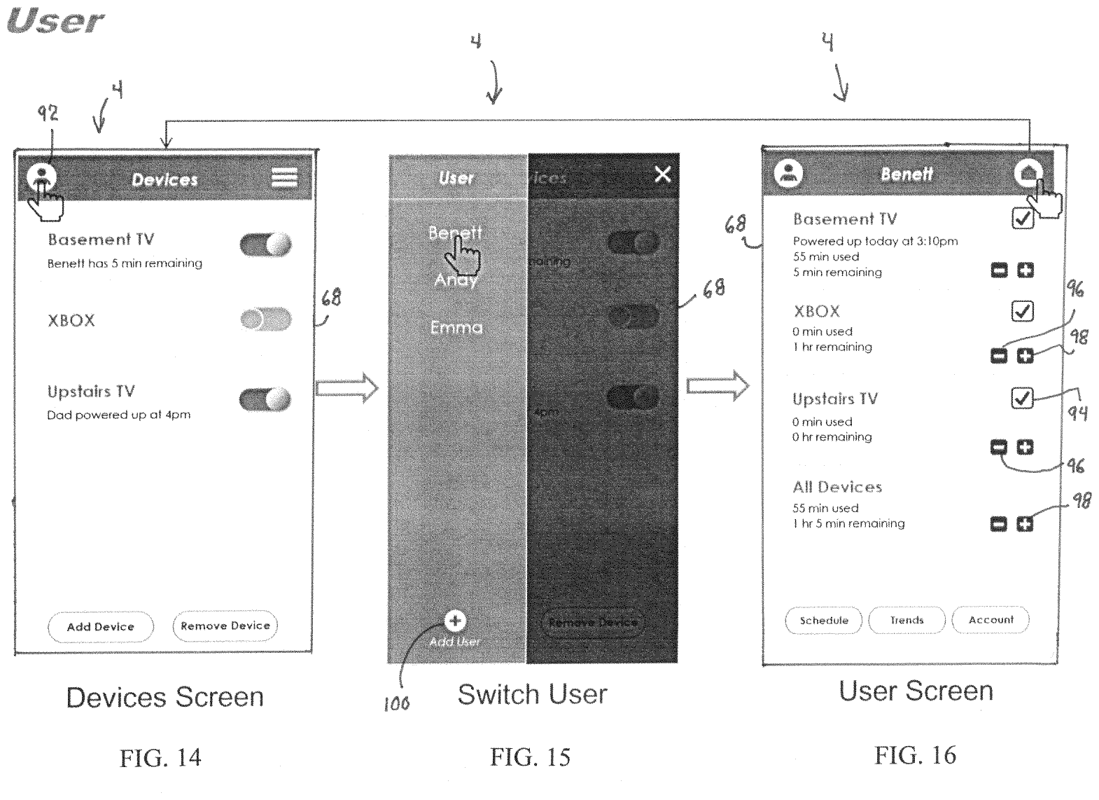

The parent's App 4a downloaded on his or her smart phone 4, in accordance with the method and system of the present invention, may also display information about each user (e.g., child) of an electrical device 6 which is controlled by the App 4a and system 2. Reference should now be had to FIGS. 14-16 of the drawings in this regard. As shown in FIG. 14, there is the simplified icon of a person 92 in the upper left hand corner of the screenshot which is displayed on the parent's smart phone 4. If the parent clicks on this person icon 92, the display 68 changes to the screenshot shown in FIG. 15 and lists the users of the electrical devices (e.g., television, gaming console and the like) 6 and information concerning the time and duration, and other parental control information, including authorization, that a particular user has with respect to each electrical device 6. For example, and as shown in FIG. 15 of the drawings, there are three names shown in the “User” column that are displayed on the parent's smart phone (that is, “Benett”, “Andy” and “Emma”) 4. If the “Benett” displayed name is clicked on, the display 68 of the parent's smart phone 4 will change to the screenshot that is shown in FIG. 16, and the electrical devices 6, and information about each electrical device 6, such as play time and duration, will be displayed, as shown in FIG. 16 of the drawings.

For example, and as shown in FIG. 16, the child identified by the displayed name “Benett” will have a list of electrical devices 6 which that particular child is permitted to use (e.g., “Basement TV”, “XBOX” and “Upstairs TV”). Also, under each identified name for an electrical device 6, information concerning the duration, time the device 6 is powered up, time remaining and time used and other miscellaneous information is displayed 6, as shown in FIG. 16.

As also shown in FIG. 16, next to each displayed electrical device 6, there is a field 94 in which either a check mark appears or no check mark appears. When the parent, using the App 4a on the parent's smart phone 4, clicks on the box (field 94) and puts a check mark next to a particular electrical device 6 that is displayed on the parent's smart phone 4, that renders that particular device 6 available for operation by that child (e.g., Benett) only. Then, when Benett opens his App 8a on his smart phone 8, he would now see that device 6 listed, and have the ability to turn it on or off according to whatever schedule has been set up by the parent. If no check mark appears in the box (field 94) adjacent to the name of the electrical device 6, then this signifies that the parent has not given the child (e.g., Benett) authorization to activate the non-checked electrical device 6, and Benett would be precluded from operating the device 6 with his smart phone 8. The device 6 for which no authorization to use has been granted would not be displayed on the child's (e.g., Benett's) smart phone 8. If the parent then went to another child (e.g., Emma), the same electrical devices 6 would be listed for Emma on the display of the parent's smart phone 8, with no check marks yet, and the parent would need to put a check mark in the field 94 next to one or more electrical devices 6 displayed on the parent's smart phone 8 to authorize that child (e.g, Emma) to see and use each particular electrical device 6 for which authorization has been granted by the parent. Again, this child (e.g., Emma) will see on the display of her smart phone 8 only those electrical devices 6 for which authorization to use has been granted by the parent.

As also shown in FIG. 16 of the drawings, the screenshot that is displayed on the parent's display 68 has a minus (“−”) icon 96 and a plus (“+”) icon 98 in proximity to each displayed electrical device name. The minus and plus icons 96, 98 may be clicked on to change the time remaining for the child (in this case, “Benett”) to watch a television or use a gaming console 6. If, for example, a child needs additional time to finish watching a television program on the “Upstairs TV”, the parent may click the plus icon 98 and add time (e.g., fifteen minutes) to the time remaining for the child to watch television on the Upstairs TV, for example, before the WiFi power outlet control plug 12 to which the Upstairs TV is connected will disconnect power to the television 6.

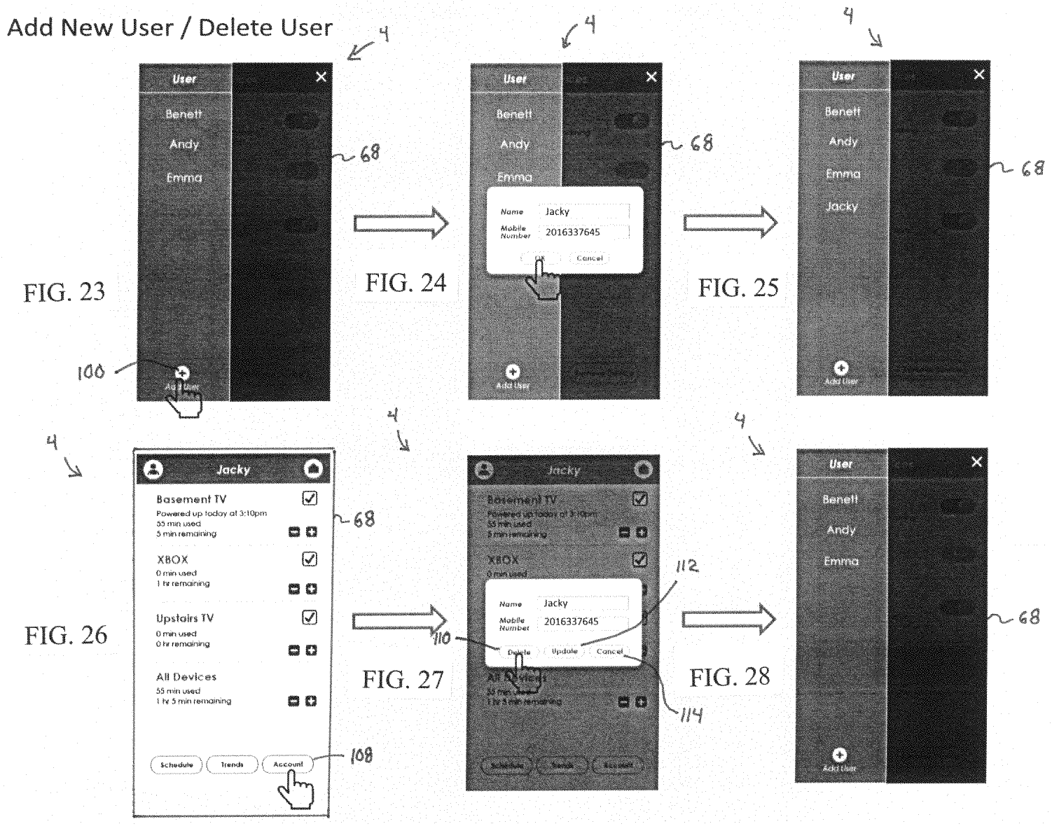

As shown in FIG. 15 of the drawings, the screenshot that is displayed on the parent's smart phone 4 has an icon 100 that reads “Add User” (as shown in the lower left hand corner of the screen display). The parent may add a user (e.g., another child) who will be controlled in his time spent and schedule of his watching television or using a gaming console 6. The software routine for adding a new user is illustrated by the screenshots shown in FIGS. 23-25 of the drawings.

As shown in FIG. 23, the hand cursor is placed over (or the parent touches with his finger) the “Add User” icon 100 and the icon 100 is clicked on. The display screen 68 on the parent's smart phone 4 will now change to that shown in FIG. 24 in which a field 102 appears with the name and mobile telephone number (e.g., cell phone number) of the person to be added (for example, “Jacky” and “Jacky@gmail.com” or “999-999-9999”). In the displayed field 102 there is an “OK” button icon 104 and a “Cancel” button icon 106 which may be pressed (or clicked on). If the information, such as the name and mobile telephone number are correctly entered, then the parent will press the “OK” button (or press the “Cancel” button if the information needs to be reentered) 104, and the display 68 will proceed to the screenshot shown in FIG. 25, where it is shown that the name “Jacky” has now been added and listed as a user along with the names “Benett”, “Andy” and “Emma”.

To delete a user from the control of the App 4a on the parent's smart phone 4, this feature is illustrated by FIGS. 26-28 of the drawings. As shown in FIG. 26, an “Account” button icon 108 appears on the display 68 of the parent's smart phone 4, which may be clicked on by the parent using the hand cursor (or his finger). The parent's smart phone 4 then displays the screenshot shown in FIG. 27, with the user's name and mobile number, and icon buttons labeled “Delete” 110 “Update” 112 and “Cancel” 114. The parent may select “Delete” to remove that particular user from the control of the App 4a. The display 68 will then progress to the screenshot shown in FIG. 28, which now omits the name “Jacky” from the list of users that are controlled by the system 2 and method of the present invention. If the parent modifies the name or mobile number of that user, thereafter selecting the “Update” button 112 will implement those changes. Selecting “Cancel” 114 allows the parent to exit the account modification screen without making any changes.

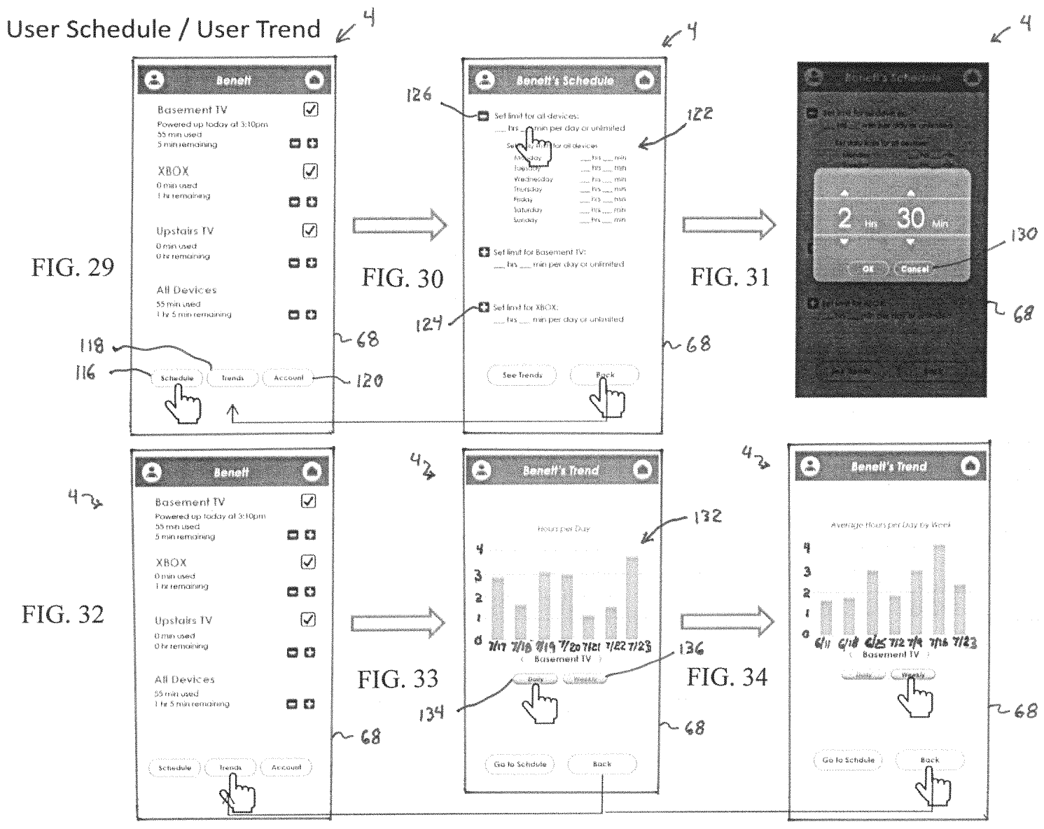

The parent also has the ability to set a user's schedule and view the trends of a user in viewing or using an electrical device 6 controlled by the system 2 and method of the present invention and the parent's App 4a. Reference should now be had to FIGS. 29-31 of the drawings which show screenshots of displays of the parent's smart phone 4 and how a parent may schedule the time and duration of a child's use of a television or gaming console 6, or the like. As can be seen in FIG. 29, the display 68 on the parent's smart phone 4 has three button icons situated at the lower portion thereof, that is, the button “Schedule” 116 an adjacent button “Trends” 118 and adjacent button “Account” 120. FIG. 29 is the same as the “User Screen” displayed for the user “Benett” that is shown in FIG. 16, and is repeated here to facilitate an understanding of the invention. If the button icon “Schedule” 116 is pressed by the parent on his touch screen, or the hand cursor is used to click on this icon 116, as indicated in FIG. 29, the display on the parent's smart phone 4 will change to the screenshot shown in FIG. 30. As shown, limits may be set for individual electrical devices (for example, “Basement TV”, “XBOX”, “Upstairs TV”) 6 or limits may be set for all devices 6 which “Benett” has permission to utilize. As shown in FIG. 30, a drop down menu 122 will appear with more details if a plus (“+”) 124 or minus (“−”) 126 icon (respectively used to expand or reduce the informational field) displayed next to the identified electrical device 6 listed for the user named “Benett” is clicked on or pressed on the parent's display 68 so that the parent may set the number of hours and minutes for individual days of the week that certain electrical devices 6, or all devices 6, may be activated by the WiFi power outlet control plug 12 to which they are connected. Alternatively, time limits may be set for each electrical device 6, or all devices, by entering the hours and minutes next to the displayed device, as a short cut, and such time limits will apply to all days of the week. After this information is entered, the hours and minutes of the time limits that are entered by the parent are displayed, as shown in the screenshot of FIG. 31, for the parent to confirm as being correct. The parent may then press the “Ok” button icon 128 and the selected time limits will then be entered into the system 2 and the parent's App 4a, or the parent may press the “Cancel” button icon 130 in order to change the time limits which were entered earlier.

For each electrical device 6, or for all electrical devices 6, used by an individual user, the parent may select an “unlimited” use of such devices 6 by an individual user. If a child is operating with unlimited time, what is displayed is the time used instead of the time remaining. In this mode, the parent may set a configurable default countdown timer at which point the electrical device 6 is forced to power down unless it is extended by the child within a predetermined time after a notification is displayed on the child's display 68.

Information is also provided to the parent as to the television watching or game playing time of each child. As shown in the screenshot of FIG. 32 of the drawings, if the button icon “Trends” 118 on the parent's display 68 is pressed, then what appears for the parent on his or her smart phone 4 is a bar graph 132 or other form of graph or information relating to the hours per day or weekly trends that a particular electrical device (for example, the “Basement TV”) was watched by a particular user (for example, “Benett”). The screenshot which displays this information is shown in FIG. 33. Alternatively, the daily or weekly trends of total device use by an individual user may be displayed. As shown in FIG. 33, for a daily bar graph 132 of use to be displayed, the parent presses on the “Daily” button icon 134 that appears on his or her display. For weekly trends for a particular child, the parent presses the “Weekly” button icon 136, and the average hours per day by week will be displayed as a bar graph 132 on the parent's display 68, as shown in FIG. 34 of the drawings.

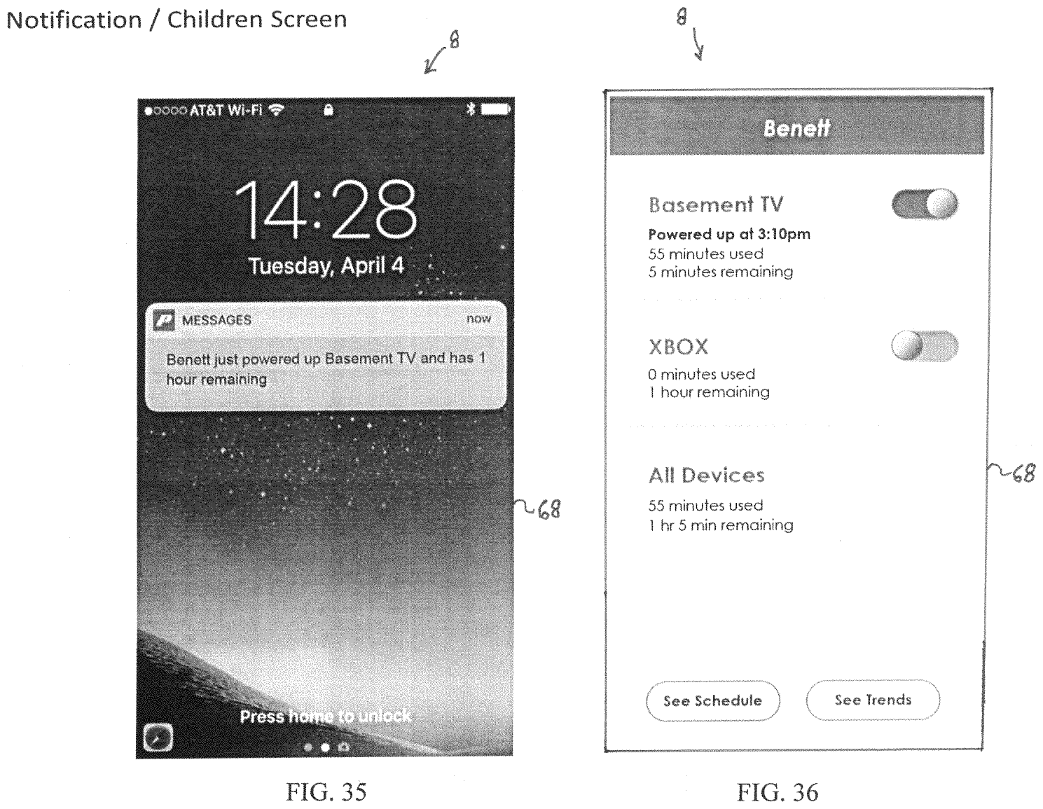

FIGS. 35 and 36 illustrate screenshots of what is displayed on a child's smart phone 8 after a child's App 8a formed in accordance with the present invention is downloaded thereon. As shown in FIG. 35, notifications are displayed on a child's smart phone 8, including what electrical device 6 has been activated and the time remaining for use of such an electrical device 6, as well as other informational notifications provided to the child. Then, the display 68 on the child's smart phone 8 will display the screenshot shown in FIG. 36 to show the electrical devices 6, such as televisions and gaming consoles, which the child has permission to use, and informational messages for each electrical device 6 or for all devices that the child is permitted to use, such as the amount of time used, the time remaining or the time at which a particular electrical device 6 was turned on.

The system 2 and method of the present invention for parental control of a child's use of televisions and gaming consoles 6 and the like, all of which are controllable by WiFi power outlet control plugs 12 formed in accordance with the present invention, provide three primary functions in relation to the electrical devices 6 that are controlled by the method and system 2. These primary functions are awareness, interactive control and data reporting. With respect to awareness, the parent now has visibility into the usage by child per device and across devices 6, and the child has visibility into his own usage. With respect to interactive control, the parent can instantly power down an electrical device 6. The parent can set and adjust limits to a child's use of a television, gaming console or the like 6, and the child can initiate, pause and resume watching television or gaming. With respect to data reporting, the parent can see the device usage trends for each child. Collective intelligence allows a parent to benchmark his own child's usage against the broader user base.

There are many notifications which the system 2 and method of the present invention provide to a parent on the parent's smart phone 4 on which the App 4a of the present invention is downloaded. With reference to each child, and for simplicity and by way of example, the child's name is referred to herein as “Benett”, the following notifications may be received on the parent's smart phone 4: “Benett just powered up Basement TV and has 1 hour remaining”; “Benett just powered down Basement TV”; “Benett has 5 minutes remaining on Basement TV” (the child “Benett” also receives this notification on his smart phone); “Benett just reached his usage limit on Basement TV” (the child “Benett” also receives this notification on his smart phone); and “Benett just reached his usage limit on All Devices” (the child “Benett” also receives this notification on his smart phone).

On the child's smart phone 8 on which the child's App 8a of the present invention is downloaded, the child will also receive the following notifications (it is assumed by way of example that the child referred to herein is named “Benett”): “Benett, Basement TV will power down in 5 minutes!”; and “Benett, Dad just powered down Basement TV”.

The lockable WiFi power outlet control plug 12 formed in accordance in the present invention toggles power on and off for a particular media or electrical device 6 which is connected thereto. The control plug 12 accommodates standard power outlets and WiFi networks. The particular structure of the control plug 12 of the present invention locks the power cord 38 of the media or electrical device 6 thereto so that the power cord 38 may not be removed therefrom.

Each child, with permission from his parent, may power up a television, gaming console, or other media or electrical device 6 using his smart phone 8 on which the child's App 8a is downloaded. Thus, if one child (e.g., “Lucas”) powered up an XBOX gaming console, Lucas' smart phone 8, and that of the parent, would display the XBOX gaming console that is activated with the name “Lucas” next to the device's name. Another child (e.g., “Benett”) would not be able to power down the XBOX gaming console. The time used/remaining would still be that of the second child (“Benett”), as Lucas' use of the gaming console (e.g., XBOX) would not decrease the time allotted to the second child (“Bennet”) for use of that gaming console.

The power outlet control plug 12, system 2 employing the power outlet control plug 12 and method of the present invention will now be further described.

A power outlet control plug 12 formed in accordance with the present invention selectively provides power from an AC outlet to an electrical device 6. The electrical device 6 includes a power cable 38, the power cable 38 having a first axial end and a second axial end disposed opposite the first axial end. The first axial end is electrically coupled to the electrical device 6. The power cable 38 further has a power plug 36 situated on the second axial end thereof, the power plug 36 of the power cable 38 of the electrical device 6 being receivable by the power outlet control plug 12.

The power outlet control plug 12 preferably includes a cowling 54 defining an interior cavity 40 and having a front end portion 42 and a rear end portion 46 situated opposite the front end portion 42. The front end portion 42 of the cowling 54 has a front opening 44 formed therein which is in communication with the interior cavity 40. The rear end portion 46 of the cowling 54 has a rear opening 53 formed therein which is also in communication with the interior cavity 40. The power plug 36 of the power cable 38 is selectively insertable through the rear opening 53 formed in the rear end portion 46 of the cowling 54.

The power outlet control plug 12 of the present invention also includes a smart plug 14 mounted within the front end portion 42 of the cowling 54 and being secured therein. The smart plug 14 has a housing 22, the housing 22 having an outer face 24 and an inner face 30 situated opposite the outer face 24, power prongs 26 situated on the outer face 24 and extending outwardly therefrom at the front opening 44 of the cowling 54 so as to be receivable by the AC outlet and a power receptacle 32 including contacts 33 situated on the inner face 30 for receiving the power plug 36 of the power cable 38 so as to selectively provide power to the electrical device 6. The housing 22 of the smart plug 14 defines an internal space 157 and has electrical circuitry 158 situated in the internal space 157. The electrical circuitry 158 is switchable between a first state to cause an electrical connection between the power prongs 26 and the receptacle contacts 33 such that power can be selectively provided from the AC outlet to the electrical device 6, and a second state to cause an electrical disconnection between the power prongs 26 and the receptacle contacts 33 such that power is not provided from the AC outlet to the electrical device 6. The electrical circuitry 158 is responsive to at least one control signal provided by at least one external computing device 9 and causes the electrical circuitry 158 to be switched between the first state and the second state in response thereto.

The power outlet control plug 12 of the present invention further includes a locking mechanism 62. The locking mechanism 62 is selectively engageable with the cowling 54 to lock the power plug 36 of the power cable 38 to the cowling 54 and prevent removal therefrom when the power plug 36 is received thereby.

Preferably, the rear end portion 46 of the cowling 54 includes a sidewall 48 having an open top 50 and an open axial rear end 52. Even more preferably, the sidewall 48 of the rear end portion 46 of the cowling 54 is generally U-shaped in transverse cross-section. Furthermore, the locking mechanism 62 is selectively engageable with the sidewall 48 of the rear end portion 46 of the cowling 54.

Even more preferably, the sidewall 48 of the rear end portion 46 of the cowling 54 of the power outlet control plug 12 includes a first wall portion 48a and a second wall portion 48b situated opposite the first wall portion 48a, and at least one opening 56 formed through the thickness of each of the first wall portion 48a and the second wall portion 48b, the at least one opening 56 formed in the first wall portion 48a being situated opposite the at least one opening 56 formed in the second wall portion 48b. Furthermore, the locking mechanism 62 includes a main lock body 63 and at least one elongated locking member 60 extending therefrom, the at least one locking member 60 being selectively engageable with the main lock body 63 and being selectively insertable through the at least one opening 56 in the first wall portion 48a and the at least one opening 56 in the second wall portion 48b.

In yet another form of the power outlet control plug 12 described above, the at least one opening 56 formed in the first wall portion 48a includes a first opening 56a and a second opening 56b, and the at least one opening 56 formed in the second wall portion 48b includes a first opening 56a and a second opening 56b, the first opening 56a in the first wall portion 48a being situated opposite the first opening 56a in the second wall portion 48b, and the second opening 56b in the first wall portion 48a being situated opposite the second opening 56b in the second wall portion 48b. Additionally, the at least one elongated locking member 60 of the locking mechanism 62 includes at least one flexible cable 60, the at least one flexible cable 60 being insertable through at least one of the first opening 56a in the first wall portion 48a and the first opening 56a in the second wall portion 48b, and the second opening 56b in the first wall portion 48a and the second opening 56b in the second wall portion 48b.

In yet another form of the power outlet control plug 12 of the present invention, the front end portion 42 of the cowling 54 further includes a flange 55. The flange 55 extends partially radially inwardly at the front opening 44 of the cowling 54 to prevent the smart plug 14 from being removed through the front opening 44 of the cowling 54.

Also, the smart plug 14 may include a switch 66. The switch 66 is mounted on the housing 22 and is in electrical communication with the electrical circuitry 158 of the smart plug 14. Furthermore, the front end portion 42 of the cowling 54 has formed through the thickness thereof a switch access opening 64, the switch access opening 64 being situated in alignment with the switch 66 of the smart plug 14.

A system 2 for monitoring electrical device usage and controlling power thereto, formed in accordance with the present invention, includes at least one power outlet control plug 12 having the structure and functionality of one of the embodiments described above. The system 2 further includes at least one external computing device 9, the at least one external computing device 9 being operable by a user of the system 2.

Preferably, the at least one external computing device 9 includes electrical circuitry 150, the electrical circuitry 150 of the at least one external computing device 9 being in electrical communication with the at least one power outlet control plug 12. The electrical circuitry 150 of the at least one external computing device 9 provides at least one control signal to the electrical circuitry 158 of the smart plug 14 of the at least one power outlet control plug 12. The at least one control signal provided by the at least one external computing device 9 causes the electrical circuitry 158 of the smart plug 14 of the at least one power outlet control plug 12 to switch between the first state and the second state.

The system 2 also includes a display 152. The display 152 is in electrical communication with the electrical circuitry 150 of the at least one external computing device 9.

The electrical circuitry 150 of the at least one external computing device 9 includes a non-transitory computer-readable storage medium 154. The non-transitory computer-readable storage medium 154 has stored thereon instructions that upon execution by the at least one external computing device 9 cause the acts including receiving an instruction from a user of the system 2 directing the system 2 to either provide power from the AC outlet to the electrical device 6 or not to provide power from the AC outlet to the electrical device 6, and causing the at least one control signal to be generated by the electrical circuitry 150 of the at least one external computing device 9. The electrical circuitry 158 of the smart plug 14 of the at least one power outlet control plug 12, in response to the at least one control signal, is caused to switch to one of the first state and the second state.

Preferably, the display 152 of the at least one external computing device 9 of the system 2 described above includes a graphical user interface 156 for displaying information and entering user instructions thereon. The information includes the state of the electrical circuitry 158 of the smart plug 14 of the at least one power outlet control plug 12. The non-transitory computer-readable storage medium 154 has stored thereon instructions that upon execution by the at least one external computing device 9 cause the act of displaying the state of the electrical circuitry 158 of the smart plug 14 of the at least one power outlet control plug 12 to the user on the display 152.

In yet another form of the present invention, the at least one external computing device 9 communicates electrically with the electrical circuitry 158 of the smart plug 14 of the at least one power outlet control plug 12 through at least one of a cellular communications network connection 16, an Internet connection 10 and a direct communication connection between the at least one external computing device 9 and the electrical circuitry 158 of the smart plug 14 of the at least one power outlet control plug 12. Furthermore, the at least one external computing device 9 is one of a laptop computer, a personal computer, a cellular telephone 4, a handheld, portable, personal assistant device, a tablet and a remote control.

Still in another form, the system 2 of the present invention for monitoring electrical device usage and controlling power thereto further includes a WiFi router 20. The WiFi router 20 provides a WiFi network connection between the at least one external computing device 9 and the at least one power outlet control plug 12. The at least one external computing device 9 communicates electrically with the electrical circuitry 158 of the smart plug 14 of the at least one power outlet control plug 12 through the WiFi router 20.

In yet another form, the system 2 of the present invention for monitoring electrical device usage and controlling power thereto further includes a control server 18. The control server 18 is in electrical communication with the electrical circuitry 158 of the smart plug 14 of the at least one power outlet control plug 12 and the electrical circuitry 150 of the at least one external computing device 9. The control server 18 includes electrical circuitry (not shown) for monitoring the state of the electrical circuitry 158 of the smart plug 14 of the at least one power outlet control plug 12. The control server 18 provides at least one information signal to the electrical circuitry 150 of the at least one external computing device 9, the at least one information signal containing information relating to at least one of the current state of the electrical circuitry 158 of the smart plug 14 of the at least one power outlet control plug 12 and the duration of the current state of the electrical circuitry 158 of the smart plug 14 of the at least one power outlet control plug 12. The electrical circuitry 150 of the at least one external computing device 9 is responsive to the at least one information signal provided by the control server 18 and causes the display 152 to display a visual indication of the current state of the electrical circuitry 158 of the smart plug 14 of the at least one power outlet control plug 12 and the duration of the current state of the electrical circuitry 158 of the smart plug 14 of the at least one power outlet control plug 12 to the user.

In yet another form, the system 2 of the present invention includes a plurality of power outlet control plugs 12 such as described above. Each power outlet control plug 12 of the plurality of power outlet control plugs 12 has device information associated therewith. The device information corresponds to the electrical device 6 in electrical communication with a respective one of the power outlet control plugs 12. The electrical circuitry 150 of the at least one external computing device 9 causes the display 152 to display visual indications of the device information and the state of the electrical circuitry 158 of the smart plug 14 of each power outlet control plug 12 of the plurality of power outlet control plugs 12 to the user.

In an alternative version of the system 2 for monitoring electrical device usage and controlling power thereto formed in accordance with the present invention, the at least one external computing device 9 includes at least one master external computing device 4 and at least one subordinate external computing device 8. The at least one master external computing device 4 is in electrical communication with the at least one subordinate external computing device 8, and the at least one master external computing device 4 selectively enables the at least one subordinate external computing device 8 to generate the at least one control signal and disables the at least one subordinate external computing device 8 from generating the at least one control signal.

A method in accordance with the present invention for monitoring usage of an electrical device 6 and selectively providing power from an AC outlet to the electrical device 6 uses a power outlet control plug 12 having the structure of one of the embodiments thereof described previously, and at least one external computing device 9 also having the structure of one of the embodiments thereof described previously. The method includes the steps of connecting the power plug 36 of the power cable 38 of the electrical device 6 with the power outlet control plug 12 of the present invention described previously.

The method further includes the steps of displaying the state of the electrical circuitry 158 of the smart plug 14 of the power outlet control plug 12 on at least one display 152, and receiving instructions from a user on the at least one external computing device 9 to direct the power outlet control plug 12 to at least one of provide power from the AC outlet to the electrical device 6 and not to provide power from the AC outlet to the electrical device 6.

The method further includes the step of causing the at least one external computing device 9 to generate the at least one control signal corresponding to the instructions from the user, the electrical circuitry 158 of the smart plug 14 of the power outlet control plug 12, in response to the at least one control signal, being caused to switch to one of the first state and the second state.

In yet another form of the present invention, the method further includes the steps of determining by the at least one external computing device 9 the duration of time that the electrical circuitry 158 of the smart plug 14 of the power outlet control plug 12 is in a current state of one of the first state and the second state, and displaying the duration of time that the electrical circuitry 158 of the smart plug 14 of the power outlet control plug 12 is in the current state on the at least one display 152.

The method of the present invention, in yet another form, further includes the steps of receiving instructions from the user on the at least one external computing device 9 corresponding to a duration of time that the electrical circuitry 158 of the smart plug 14 of the power outlet control plug 12 is to be in at least one of the first state and the second state, and causing the at least one external computing device 9 to generate the at least one control signal to switch from the current state of the electrical circuitry 158 of the smart plug 14 of the power outlet control plug 12 to one of the first state and the second state when the duration of time has been reached.

In one form of the present invention, the power outlet control plug 12 has device information associated therewith which corresponds to the electrical device 6 in electrical communication therewith. Accordingly, in yet another preferred form of the method of the present invention, the method further comprises the step of displaying the device information associated with the power outlet control plug 12 on the at least one display 152.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A power outlet control plug for selectively providing power from an AC outlet to an electrical device, the electrical device including a power cable, the power cable having a first axial end and a second axial end disposed opposite the first axial end, the first axial end being electrically coupled to the electrical device, the power cable further having a power plug situated on the second axial end thereof, the power plug of the power cable of the electrical device being receivable by the power outlet control plug, which comprises:
a cowling defining an interior cavity and having a front end portion and a rear end portion situated opposite the front end portion, the front end portion of the cowling having a front opening formed therein which is in communication with the interior cavity, the rear end portion of the cowling having a rear opening formed therein which is in communication with the interior cavity, the power plug of the power cable being selectively insertable through the rear opening formed in the rear end portion of the cowling;
a smart plug mounted within the front end portion of the cowling and being secured therein, the smart plug having a housing, the housing having an outer face and an inner face situated opposite the outer face, power prongs situated on the outer face and extending outwardly therefrom at the front opening of the cowling so as to be receivable by the AC outlet and a power receptacle including contacts situated on the inner face for receiving the power plug of the power cable so as to selectively provide power to the electrical device, the housing of the smart plug defining an internal space and having electrical circuitry situated in the internal space, the electrical circuitry being switchable between a first state to cause an electrical connection between the power prongs and the receptacle contacts such that power can be selectively provided from the AC outlet to the electrical device, and a second state to cause an electrical disconnection between the power prongs and the receptacle contacts such that power is not provided from the AC outlet to the electrical device, the electrical circuitry being responsive to at least one control signal provided by at least one external computing device and causing the electrical circuitry to be switched between the first state and the second state in response thereto; and
a locking mechanism, the locking mechanism being selectively engageable with the cowling to lock the power plug of the power cable to the cowling and prevent removal therefrom when the power plug is received thereby.

2. A power outlet control plug as defined by claim 1, wherein the rear end portion of the cowling includes a sidewall having an open top and an open axial rear end.

3. A power outlet control plug as defined by claim 2, wherein the sidewall of the rear end portion of the cowling is generally U-shaped in transverse cross-section.

4. A power outlet control plug as defined by claim 2, wherein the locking mechanism is selectively engageable with the sidewall of the rear end portion of the cowling.

5. A power outlet control plug as defined by claim 2, wherein the sidewall of the rear end portion of the cowling includes a first wall portion and a second wall portion situated opposite the first wall portion, and at least one opening formed through the thickness of each of the first wall portion and the second wall portion, the at least one opening formed in the first wall portion being situated opposite the at least one opening formed in the second wall portion; and
wherein the locking mechanism includes a main lock body and at least one elongated locking member extending therefrom, the at least one locking member being selectively engageable with the main lock body and being selectively insertable through the at least one opening in the first wall portion and the at least one opening in the second wall portion.

6. A power outlet control plug as defined by claim 5, wherein the at least one opening formed in the first wall portion includes a first opening and a second opening, and wherein the at least one opening formed in the second wall portion includes a first opening and a second opening, the first opening in the first wall portion being situated opposite the first opening in the second wall portion, and the second opening in the first wall portion being situated opposite the second opening in the second wall portion; and
wherein the at least one elongated locking member of the locking mechanism includes at least one flexible cable, the at least one flexible cable being insertable through at least one of the first opening in the first wall portion and the first opening in the second wall portion, and the second opening in the first wall portion and the second opening in the second wall portion.

7. A power outlet control plug as defined by claim 1, wherein the front end portion of the cowling further comprises:
a flange, the flange extending partially radially inwardly at the front opening of the cowling to prevent the smart plug from being removed through the front opening of the cowling.

8. A power outlet control plug as defined by claim 1, wherein the smart plug further includes a switch, the switch being mounted on the housing and being in electrical communication with the electrical circuitry of the smart plug; and
wherein the front end portion of the cowling has formed through the thickness thereof a switch access opening, the switch access opening being situated in alignment with the switch of the smart plug.

9. A system for monitoring electrical device usage and controlling power thereto, which comprises:
at least one power outlet control plug, wherein the at least one power outlet control plug includes:
a cowling defining an interior cavity and having a front end portion and a rear end portion situated opposite the front end portion, the front end portion of the cowling having a front opening formed therein which is in communication with the interior cavity, the rear end portion of the cowling having a rear opening formed therein which is in communication with the interior cavity, the power plug of the power cable being selectively insertable through the rear opening formed in the rear end portion of the cowling;
a smart plug mounted within the front end portion of the cowling and being secured therein, the smart plug having a housing, the housing having an outer face and an inner face situated opposite the outer face, power prongs situated on the outer face and extending outwardly therefrom at the front opening of the cowling so as to be receivable by the AC outlet and a power receptacle including contacts situated on the inner face for receiving the power plug of the power cable so as to selectively provide power to the electrical device, the housing of the smart plug defining an internal space and having electrical circuitry situated in the internal space, the electrical circuitry being switchable between a first state to cause an electrical connection between the power prongs and the receptacle contacts such that power can be selectively provided from the AC outlet to the electrical device, and a second state to cause an electrical disconnection between the power prongs and the receptacle contacts such that power is not provided from the AC outlet to the electrical device, the electrical circuitry being responsive to at least one control signal provided by at least one external computing device and causing the electrical circuitry to be switched between the first state and the second state in response thereto; and
a locking mechanism, the locking mechanism being selectively engageable with the cowling to lock the power plug of the power cable to the cowling and prevent removal therefrom when the power plug is received thereby; and
at least one external computing device, the at least one external computing device being operable by a user of the system;
wherein the at least one external computing device includes:
electrical circuitry, the electrical circuitry of the at least one external computing device being in electrical communication with the at least one power outlet control plug, the electrical circuitry of the at least one external computing device providing at least one control signal to the electrical circuitry of the smart plug of the at least one power outlet control plug, the at least one control signal provided by the at least one external computing device causing the electrical circuitry of the smart plug of the at least one power outlet control plug to switch between the first state and the second state; and
a display, the display being in electrical communication with the electrical circuitry of the at least one external computing device;
wherein the electrical circuitry of the at least one external computing device includes a non-transitory computer-readable storage medium, the non-transitory computer-readable storage medium having stored thereon instructions that upon execution by the at least one external computing device cause the acts comprising:
receiving an instruction from a user of the system directing the system to either provide power from the AC outlet to the electrical device or not to provide power from the AC outlet to the electrical device; and
causing the at least one control signal to be generated by the electrical circuitry of the at least one external computing device, the electrical circuitry of the smart plug of the at least one power outlet control plug, in response to the at least one control signal, being caused to switch to one of the first state and the second state.

10. A system for monitoring electrical device usage and controlling power thereto as defined by claim 9, wherein the display of the at least one external computing device comprises a graphical user interface for displaying information and entering user instructions thereon, wherein the information includes the state of the electrical circuitry of the smart plug of the at least one power outlet control plug, wherein the non-transitory computer-readable storage medium has stored thereon instructions that upon execution by the at least one external computing device cause the act of displaying the state of the electrical circuitry of the smart plug of the at least one power outlet control plug to the user on the display.

11. A system for monitoring electrical device usage and controlling power thereto as defined by claim 9, wherein the at least one external computing device communicates electrically with the electrical circuitry of the smart plug of the at least one power outlet control plug through at least one of a cellular communications network connection, an Internet connection and a direct communication connection between the at least one external computing device and the electrical circuitry of the smart plug of the at least one power outlet control plug.

12. A system for monitoring electrical device usage and controlling power thereto as defined by claim 9, wherein the at least one external computing device is one of a laptop computer, a personal computer, a cellular telephone, a handheld, portable, personal assistant device, a tablet and a remote control.

13. A system for monitoring electrical device usage and controlling power thereto as defined by claim 9, which further comprises:
a WiFi router, the WiFi router providing a WiFi network connection between the at least one external computing device and the at least one power outlet control plug, wherein the at least one external computing device communicates electrically with the electrical circuitry of the smart plug of the at least one power outlet control plug through the WiFi network.

14. A system for monitoring electrical device usage and controlling power thereto as defined by claim 9, which further comprises:
a control server, the control server being in electrical communication with the electrical circuitry of the smart plug of the at least one power outlet control plug and the electrical circuitry of the at least one external computing device, the control server including electrical circuitry for monitoring the state of the electrical circuitry of the smart plug of the at least one power outlet control plug, the control server providing at least one information signal to the electrical circuitry of the at least one external computing device, the at least one information signal containing information relating to at least one of the current state of the electrical circuitry of the smart plug of the at least one power outlet control plug and the duration of the current state of the electrical circuitry of the smart plug of the at least one power outlet control plug, the electrical circuitry of the at least one external computing device being responsive to the at least one information signal provided by the control server and causing the display to display a visual indication of the current state of the electrical circuitry of the smart plug of the at least one power outlet control plug and the duration of the current state of the electrical circuitry of the smart plug of the at least one power outlet control plug to the user.

15. A system for monitoring electrical device usage and controlling power thereto as defined by claim 9, wherein the at least one power outlet control plug includes a plurality of power outlet control plugs, and wherein each power outlet control plug of the plurality of power outlet control plugs has device information associated therewith, the device information corresponding to the electrical device in electrical communication with a respective one of the power outlet control plugs, wherein the electrical circuitry of the at least one external computing device causes the display to display visual indications of the device information and the state of the electrical circuitry of the smart plug of each power outlet control plug of the plurality of power outlet control plugs to the user.

16. A system for monitoring electrical device usage and controlling power thereto as defined by claim 9, wherein the at least one external computing device includes at least one master external computing device and at least one subordinate external computing device, wherein the at least one master external computing device is in electrical communication with the at least one subordinate external computing device, and wherein the at least one master external computing device selectively enables the at least one subordinate external computing device to generate the at least one control signal and disables the at least one subordinate external computing device from generating the at least one control signal.

17. A method for monitoring usage of an electrical device and selectively providing power from an AC outlet to the electrical device, the electrical device including a power cable, the power cable having a first axial end and a second axial end disposed opposite the first axial end, the first axial end being electrically coupled to the electrical device, the power cable further having a power plug situated on the second axial end thereof, the method comprising the steps of:
connecting the power plug of the power cable of the electrical device with a power outlet control plug, the power outlet control plug including:
a cowling defining an interior cavity and having a front end portion and a rear end portion situated opposite the front end portion, the front end portion of the cowling having a front opening formed therein which is in communication with the interior cavity, the rear end portion of the cowling having a rear opening formed therein which is in communication with the interior cavity, the power plug of the power cable being selectively insertable through the rear opening formed in the rear end portion of the cowling;
a smart plug mounted within the front end portion of the cowling and being secured therein, the smart plug having a housing, the housing having an outer face and an inner face situated opposite the outer face, power prongs situated on the outer face and extending outwardly therefrom at the front opening of the cowling so as to be receivable by the AC outlet and a power receptacle including contacts situated on the inner face for receiving the power plug of the power cable so as to selectively provide power to the electrical device, the housing of the smart plug defining an internal space and having electrical circuitry situated in the internal space, the electrical circuitry being switchable between a first state to cause an electrical connection between the power prongs and the receptacle contacts such that power can be selectively provided from the AC outlet to the electrical device, and a second state to cause an electrical disconnection between the power prongs and the receptacle contacts such that power is not provided from the AC outlet to the electrical device, the electrical circuitry being responsive to at least one control signal provided by at least one external computing device and causing the electrical circuitry to be switched between the first state and the second state in response thereto; and
a locking mechanism, the locking mechanism being selectively engageable with the cowling to lock the power plug of the power cable to the cowling and prevent removal therefrom when the power plug is received thereby;
displaying the state of the electrical circuitry of the smart plug of the power outlet control plug on at least one display;
receiving instructions from a user on the at least one external computing device to direct the power outlet control plug to at least one of provide power from the AC outlet to the electrical device and not to provide power from the AC outlet to the electrical device; and
causing the at least one external computing device to generate the at least one control signal corresponding to the instructions from the user, the electrical circuitry of the smart plug of the power outlet control plug, in response to the at least one control signal, being caused to switch to one of the first state and the second state.

18. A method as defined by claim 17, which further comprises the steps of:
determining by the at least one external computing device the duration of time that the electrical circuitry of the smart plug of the power outlet control plug is in a current state of one of the first state and the second state; and
displaying the duration of time that the electrical circuitry of the smart plug of the power outlet control plug is in the current state on the at least one display.

19. A method as defined by claim 18, which further comprises the steps of:
receiving instructions from the user on the at least one external computing device corresponding to a duration of time that the electrical circuitry of the smart plug of the power outlet control plug is to be in at least one of the first state and the second state; and
causing the at least one external computing device to generate the at least one control signal to switch from the current state of the electrical circuitry of the smart plug of the power outlet control plug to one of the first state and the second state when the duration of time has been reached.

20. A method as defined by claim 17, wherein the power outlet control plug has device information associated therewith which corresponds to the electrical device in electrical communication therewith, and wherein the method further comprises the step of:
displaying the device information associated with the power outlet control plug on the at least one display.
